(19) United States
(12) Patent Application Publication
(10) Pub. No.: US 2007/0296227 A1
(43) Pub. Date: Dec. 27, 2007

(54) BAG ASSEMBLY FOR AN EXCREMENT COLLECTING APPARATUS

(76) Inventor: Ben Li, Holywood (GB)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 11/751,929

(22) Filed: May 22, 2007

(30) Foreign Application Priority Data
May 23, 2006 (GB) 0610190.1

(51) Int. Cl. A01K 29/00

(52) U.S. Cl. 294/1.3

(57) ABSTRACT

A bag assembly for an excrement collecting apparatus. The bag assembly comprises a bag and a collar, the collar being engaged with an open end portion of the bag such that the end portion is wrapped around the collar. A rib is provided at the end portion, the collar being shaped to define a seat for the rib, the bag and collar being assembled such that the rib is seated in the seat to releasably secure the bag to the collar. The arrangement provides a secure coupling between the bag and the collar and reduces the risk that the bag will tear when pulled.

### FIELD OF THE INVENTION

The present invention relates to a bag assembly especially for use with an excrement collecting apparatus.

### BACKGROUND TO THE INVENTION

A number of apparatus require, as a component part, a bag assembly comprising a bag and a collar, the collar typically being located at the mouth of the bag. One such application is an apparatus for collecting pet, usually dog, excrement, commonly known as a “pooper scooper”. Some types of pooper scooper include a removable bag in which collected excrement is stored. In order that the bag may be fitted to the pooper scooper such that its mouth is held open, a collar or ring is provided around the mouth of the bag. Typically, at least the bag, and usually also the collar, are formed from plastics.

A problem that can arise is that the attachment of the bag and collar is not robust and so, during use, and particularly when attempting to remove the bag from the pooper scooper, the bag becomes detached from the collar.

It would be desirable, therefore, to provide improved means for attaching a bag to a collar.

### SUMMARY OF THE INVENTION

Accordingly, a first aspect of the invention provides an assembly of a bag and a collar, wherein at least one rib is provided at, or adjacent, the mouth of the bag, the bag and collar being assembled such that the rib engages with a trailing edge of the collar.

The rib may be co-formed with the bag and may extend around substantially the entire periphery of the mouth.

A second aspect of the invention provides an apparatus for collecting excrement, the apparatus being arranged to removably receive the bag assembly of the first aspect of the invention. The excrement collecting apparatus may include an end piece to which said collar is removably fitted during use.

Further advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1A is a cross sectional side view of a bag assembly embodying the invention;

FIG. 1B is an end view of the bag assembly of FIG. 1A;

FIG. 2 is a cross sectional side view of the bag assembly of FIG. 1, the assembly being fitted to an end piece of a pooper scooper;

FIG. 3 is an enlarged view of part of the assembly of FIG. 1, showing the mouth of the bag and a collar;

FIG. 4 is an enlarged view of part of the illustration of FIG. 2, showing the collar and bag fitted to the end piece; and

FIG. 5 shows the mouth of the bag and a rib.

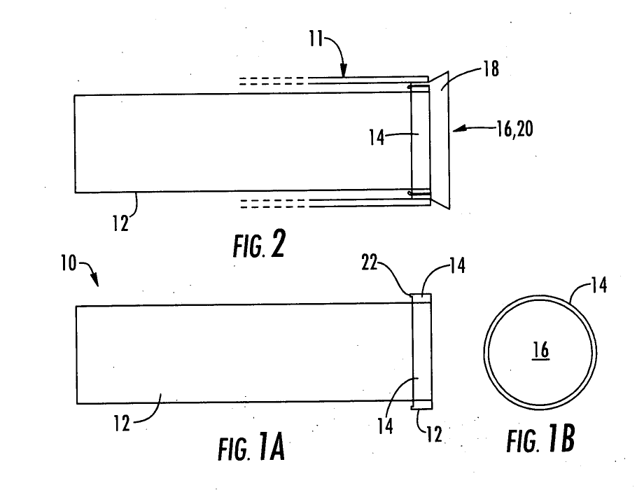

### DETAILED DESCRIPTION OF THE DRAWINGS

Referring now to the drawings, there is shown, generally indicated as 10, a bag assembly comprising a bag 12 and a ring or collar 14. The bag 12 is typically formed from plastics, for example, polypropylene or polyethylene, or other suitable flexible material, e.g., a paper-based material or a textile or fabric. The plastics, or other material used to form the bag, is usually of a relatively thin gauge and can tear easily. The bag 12 is formed from a material that is not self-supporting and so does not hold itself open without assistance from the collar 14.

The collar 14 may also be formed form plastics (but may be formed from a variety of other materials) but comprises a semi-rigid, or self-supporting, structure. Typically, the collar 14 is substantially rigid in an axial direction but resiliently flexible in directions perpendicular to the axial direction. In the preferred embodiment, the collar 14 is substantially circular in axial cross section and so is substantially cylindrical in shape. By way of example, the collar 14 may be formed from a material that is approximately 1-2 mm thick and approximately 5-10 mm deep. The bag 12 may also be substantially circular in transverse cross-section, although the collar and the bag may take alternative shapes.

When the bag 12 and collar 14 are assembled, the collar 14 is located at or adjacent the mouth 16 of the bag 12 such that the collar 14 holds the mouth 16 in an open state.

The bag/collar assembly 10 may then be incorporated into an appropriate apparatus, which, in the present example, is an excrement collecting apparatus, or pooper scooper, part of which is shown as 11. The excrement collecting apparatus 11 may take any form suitable for removably receiving a bag assembly embodying the invention. By way of example, FIGS. 2 and 4 show a component part, in the form of an end piece 18, of a pooper scooper. During use, the assembly 10 is fitted to the end piece 18 such that the collar 14 engages with the end piece 18. Typically, means are provided to retain the collar 14 in engagement with the end piece 18. This could, for example, include the inherent resilience of the collar 14 and/or the end piece 18, and/or one or more clips or retainers for providing a press-fit, or snap-fit, engagement. The end piece 18 is fitted to an end of the pooper scooper typically such that the bag assembly 10 is located within the body of the pooper scooper. The end piece 18 defines a mouth 20 through which excrement is gathered during use. Gathered excrement passes through the end piece 18 and into the bag 12.

When the bag 12 is full, the bag assembly 10 is removed from the end piece 18. Normally, this is achieved by pulling on the bag 12 in a direction away from the end piece 18. Conventionally, the bag 12 is attached to the collar 14 by spot welds. However, this is not a satisfactory arrangement since the bag 12 tends to become detached from the collar 14 as a user pulls on the bag 12 in an attempt to remove the assembly 10 from the end piece 18.

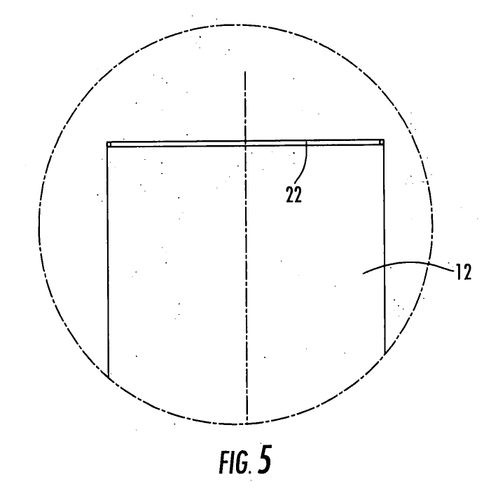

To mitigate this problem, in the assembly 10, the bag 12 is attached to the collar 14 as is described hereinafter. Referring in particular to FIG. 5, a bead, rib 22, or similar formation, is provided at or adjacent the mouth 16 of the bag 12. Preferably, the rib 22 extends around the entire, or substantially the entire, periphery of the mouth 16. The rib 22 may be said to serve as a lip around the mouth 16. Alternatively, two or more spaced-apart ribs (not illustrated) may be provided around the mouth 16. Conveniently, the rib 22 is formed at the edge of the bag 12, i.e., at the mouth 16, although this is not essential.

The rib 22 may be provided in any suitable manner. The rib 22 may be co-formed with the bag 12 during the manufacture of the bag 12, or may be fixed to or incorporated into the bag 12 in any other suitable manner. The rib 22 may, for example, be similar to the fastening ribs that are found on sealable plastics bags. Typically, the rib 22 is generally circular in transverse cross-section. In the present example, the rib 22 may be approximately 0.5 to 1 mm in diameter. The rib 22 is typically formed from plastics, but may alternatively be formed from any other suitable material, e.g., rubber or metal.

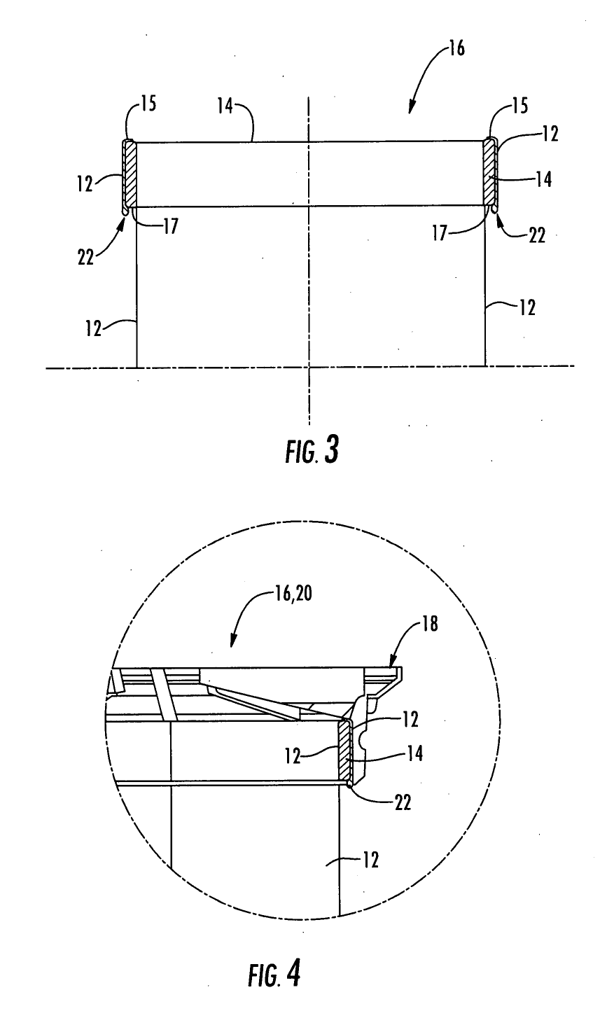

Referring now in particular to FIG. 3, the bag 12 and collar 14 are shown in an assembled state. For convenience, the collar 14 may be said to have a leading edge 15 (which runs around the open mouth of the bag 12) and a trailing edge 17 that faces away from the mouth of the bag 12). The collar 14 is located around the bag 12 adjacent the mouth 16 of the bag 12. An end portion of the bag 12 (which includes the rib 22) passes through the collar 14 and is folded over the outer surface of the collar 14 such that the rib 22 engages with the trailing edge 17 of the collar 14. The rib 22 is shaped and dimensioned so that it catches on, or engages with, the edge 17 of the collar 14. The collar 14 may, for example, be shaped to provide a seat for the rib 22. In the preferred embodiment, the width or diameter of the rib 22 is substantially equal to the width or diameter of the collar 14 to allow the rib 22 to engage with the edge 17 of the collar 14.

In the assembled state, the interaction of the rib 22 and the collar 14 prevent the bag 12 from being pulled off the collar 14 by a pulling action on the bag 12 in a direction generally away from the mouth 16. Moreover, it is found that the bag 12 tends not to rip when typical pulling forces are exerted on it.

It is noted that, in the assembled state, the location of the effective mouth of the bag 12 is at the leading edge 15 of the collar 14.

In an alternative assembled state (not illustrated), the collar 14 may be located inside the end portion of the bag 12, the end portion being folded through the collar 14 such that the rib 22 engages with the trailing edge 17. The rib 22 would then be located inside the main body of the bag 12 rather than on the outside as shown in FIG. 3.

In either embodiment, the end portion of the bag is wrapped around the collar and the rib engages with the trailing edge of the collar, or other seat provided in the collar.

FIG. 4 shows the bag assembly 10 fitted to the end piece 18 of a pooper scooper. The assembly 10 is normally retained in its fitted state by any suitable means and may be removed by tugging on the bag 12 in a direction away from the end piece 18.

In alternative embodiments (not illustrated), the bag may be fixed to the collar bay any other suitable means, e.g., spot welding. The end portion of the bag is wrapped around the collar. Should the end portion of the bag be fixed to the inside of the collar, the rest of the bag is located over the outside of the collar. Should the end portion of the bag be fixed to the outside of the collar, the rest of the bag is passed through the inside of the collar. This arrangement reduces the force exerted on the spot welds, or other fixings.

The invention is not limited to the embodiments described herein which may be modified or varied without departing from the scope of the invention.

The embodiments of the invention in which an exclusive property or privilege is claimed are defined as follows:

1. A bag assembly for an excrement collecting apparatus, the bag assembly comprising:
a bag and a collar;
said bag having an open end portion;
said collar and said end portion being engaged with one another, wherein said end portion is wrapped around said collar.

2. A bag assembly as claimed in claim 1, including at least one rib at said end portion, said collar being shaped to define a seat for said at least one rib, said bag and collar being assembled such that said at least one rib is seated in said seat to releasably secure said bag to said collar.

3. A bag assembly as claimed in claim 1, wherein said collar has a leading edge surface which defines a mouth of the bag assembly, and a trailing edge surface distal the leading edge surface, said at least one rib being seated against said trailing edge surface.

4. A bag assembly as claimed in claim 2, wherein said end portion extends from said rib over an outside surface of the collar, around said leading edge surface and through said collar.

5. A bag assembly as claimed in claim 2, wherein said end portion extends from said rib over an inside surface of the collar, around said leading edge surface and over an outside surface of the collar.

6. A bag assembly as claimed in claim 2, wherein said at least one rib is integrally formed with said bag.

7. A bag assembly as claimed in claim 2, wherein said at least one rib is provided around substantially the entire periphery of the open end of the bag.

8. A bag assembly as claimed in claim 2, wherein said at least one rib comprises a rib located substantially at a mouth defined at the open end of the bag.

9. A bag assembly as claimed in claim 1, wherein said end portion is fixed to said collar at least one fixing location, and extends from said at least one fixing location over an outside surface of the collar, around said leading edge surface and through said collar.

10. A bag assembly as claimed in claim 1, wherein said end portion is fixed to said collar at least one fixing location, and extends from said at least one fixing location over an inside surface of the collar, around said leading edge surface and over an outside surface of said collar.

11. A bag assembly as claimed in claim 1, wherein said bag is formed from plastics.

12. A bag assembly as claimed in claim 1, wherein said collar is formed from a rigid or semi-rigid material.

13. A bag assembly as claimed in claim 1, wherein said collar is substantially rigid in an axial direction and resiliently flexible in a transverse direction.

14. An excrement collecting apparatus, comprising:
a bag assembly comprising a bag and a collar;
receiving means for removably receiving said bag assembly;
said bag having an open end portion;
said collar and said end portion being engaged with one another, wherein said end portion is wrapped around said collar.

15. An excrement collecting apparatus as claimed in claim 14, wherein said receiving means includes an annular end piece which defines a mouth for the apparatus, the end piece being adapted to receive said collar.

16. An excrement collecting apparatus as claimed in claim 15, wherein said apparatus further includes means for releasably retaining said collar in said end piece.

17. An excrement collecting apparatus as claimed in claim 15, wherein said end piece and said collar are substantially concentric with one another when the collar is received by the end piece.
